(19) United States
(12) Patent Application Publication
(10) Pub. No.: US 2003/0204512 A1
(43) Pub. Date: Oct. 30, 2003

(54) System and method for controlling data communication

(75) Inventor: Rei Atarashi, Tokyo (JP)

Correspondence Address: STAAS & HALSEY LLP, SUITE 700, 1201 NEW YORK AVENUE, N.W., WASHINGTON, DC, 20005, US

(73) Assignee: Communications Research Laboratory, Independent Administrative Institution, Tokyo (JP)

(21) Appl. No.: 10/274,123

(22) Filed: Oct. 21, 2002

(30) Foreign Application Priority Data
Apr. 24, 2002 (JP) 2002-122817

(51) Int. Cl. G06F 7/00; G06F 17/00

(52) U.S. Cl. 707/100

(57) ABSTRACT

The present invention enables control to be prioritized based on data content over a network such as the Internet. In the present invention, a data sending unit adds metadata relating to data content upon data, decides priority of resources based on metadata while referring to a metapolicy, generates a packet, and sets priority at a part of the header information of the packet. A data transmission unit then refers to a DSCP table and then transmits or discards the packet based on communication control based on priority set at the packet.

### BACKGROUND OF THE INVENTION

1. Field of the Invention

This invention relates to data communication control technology for a network such as the Internet. More specifically, this invention relates to a data communication control system, a data communication control method and a computer-readable medium for recording a data communication control program employing priority based on data content in data communication over the Internet.

2. Description of the Related Art

Technology referred to as “Diffserv: Differentiated service” exists as technology for guaranteeing Quality Of Service (QOS) of Internet communication. A plurality of classes are provided for Diffserv regarding transmission services provided over the internet, with the flow of distributed data being classified into classes at a node as an entrance to a network, and with codes indicating the manner in which the data is to be handled being set. A unit for controlling data flow is then provided by carrying out packet communication control corresponding to codes indicating the class for intermediate nodes implemented, for example, using a router.

A DS code point (DSCP: Diffserv Code Point) defined so as to correspond with a prescribed class classification is set at a TOS (Type of Service) constituting part of an IP packet header in order to provide data communication control for the Diffserv. The router is equipped with a correspondence table (PHB: per-hop behavior) indicating behavior on a network corresponding in advance to DSCP and is for carrying out packet communication control in accordance with behavior corresponding to class classification of the data flow.

With Diffserv, network domains are operated according to the same rules for service class and forwarding methods for each class are referred to as DS domains (Diffserv domains). A DS domain is equipped with modules referred to as a Classifier and a Marker provided at network equipment such as a router that is an entrance to the domain boundary. The classifier divides the data flow up into classes based on prescribed rules, and the marker sets a prescribed DSCP showing behavior of the network corresponding to the class to an IP header. A router constituting the exit of the DS domain boundary carries out packet communication control based on prescribed PHB when looking at the DSCP set at the IP header.

The DSCP is constructed from a combination of a class for deciding whether or not a packet is to be sent with high priority and a discard level for defining which packets are to be discarded when the amount of data is too large to process. DSCP conforms to RFC2475 of the IETF (The Internet Engineering Task Force).

Values for DSCP conforming to RFC2475 are shown in FIG. 6. DSCP is configured from four classes of data flow c1 to c4, and three stages of packet discard levels (low discard, intermediate discard, high discard) for each respective class. Here, for example, “low level” for the packet discard level refers to transmitting the packet with top priority, “intermediate discard” refers to transmitting a packet with the next level of priority, and “high discard” refers to discarding this packet when the amount of data it is possible to process is exceeded. This means that, of the twelve AF (Assured Forwarding) values shown for the DSCP shown in FIG. 6, for example, AF11 of class c1 is a low discard, AF12 is an intermediate discard, and AF13 is a high discard.

The router within the DS domain controls packet transmission while referring to AF values defined in combination with the DSCP set in the IP packet. A DSCP conforming to RFC2475 is normally defined at the DS domain router.

FIG. 7 is a view illustrating data communication control between DS domains. A queue corresponding to the four classes of DSCP shown in FIG. 6 is provided at a router-a of a DS domain-a and transmission control is carried out according to class division of the packets. For example, the router-a refers to the DSCP of the IP header and transmits the packets (AF11 to AF13) of class c1 with high priority and then transmits the packets in the order of class c2, class c3 and class c4.

Further, at the router-a, the discard level set for each class at the router-a is set to correspond to the discard rate by setting the length of the queue. An example of settings for a queue of a router of the DS domain shown for router-a of FIG. 7 is shown in FIG. 8. The router-a sets queue lengths corresponding to the discard levels of each class of the DSCP. For example, queuing with a low discard rate for a packet can be implemented by setting the queue for the packet of DSCP=AF11 of class c1 to be long. Further, queuing with a high probability of discarding can be implemented by setting the queue of a packet where DSCP=AF13 of the same class c1 to be short. When the amount of data exceeds the possible amount of data to process, discarding takes place starting from the high discard level (AF43) packets of class c4. A router-b of a DS domain-b receiving the packet transmission then receives packets other than the discarded packets in the order of class c1, c2, c3 and c4.

In this manner, with Diffserv, data communication can be carried out with priority control by setting whether or not packets are communicated with priority according to class division of the flowing data and by setting packets to be discarded in cases such as when the amount of data is too large to process.

In the related art, DSCP for data communication control in Diffserv is set based on sending source information and sending destination information such as, for example, data types such as digital voice and moving images, IP packet source or destination address, and port number, or the like using a classifier provided at a data transmission control unit such as, for example, a router. In recent years, the Internet is being used for distributing a wide variety of information. Then, with priority control of data communication, it is necessary to perform control based on the content of the data rather than based on data type units and IP addresses, etc.

Data communication control in Diffserv of the related art is a service implemented at the network layer and transport layer and data communication control reflecting data content therefore could not be carried out. For example, with internet telephone services, there may be cases where it is desired to provide a distinction, by providing handling priority using communication control based on urgency of call content, the distinction such speech data with a content of an urgent nature from speech data for a conversation normal in content. However, in the related art, priority for transmission control of packets cannot be decided based on the content of transmitted data and priority control was therefore simply carried out based on information regarding the sending origin or sending destination such as with the destination of, for example, emergency number 110, for transmitted data. Therefore, taking an example of an internet telephone, a communication control system is therefore required that is capable of exerting control in such a manner as to give packet transmissions for urgent calls greater priority than normal calls based on call content (data content) regardless of the call destination (data sending destination) as in, for example, control exerted to give priority to urgent calls at the time of a disaster.

### SUMMARY OF THE INVENTION

It is therefore an object of the present invention to provide a system capable of carrying out prioritized control taking note of data content rather than sending source and sending destination information for data being distributed when controlling data communication over the internet.

The present invention is therefore provided with a data communication control method for carrying out data communication control over a network, comprising the steps of adding metadata related with data that is a subject of communication to the data, referring to a metapolicy making the metadata and a transmission priority correspond, deciding a transmission priority of the data based on the metadata, setting the transmission priority in a part of packet header information generated from the data, referring to a communication control table making communication control behavior correspond with each transmission priority, and deciding data packet transmission order based on the transmission priority.

The present invention is further provided with a data communication control system for carrying out data communication control comprising a data sending unit for sending data over a network and a data transmission unit for transmitting the data in accordance with header information of the received data, wherein the data sending unit comprises metapolicy storage means for storing metadata relating to the content of the data and a metapolicy making the metadata and a transmission priority correspond, and priority assigning means for referring to the metapolicy, deciding a transmission priority of the data based on the metadata, and setting the transmission priority in a part of packet header information generated from the data; and wherein the data transmission unit comprises communication control table storage means for storing a communication control table making communication control correspond with each transmission priority, and priority determining means for receiving the packet, referring to the communication control table, and determining priority of the data based on the transmission priority set in the header information.

The present invention is also provided with a data sending unit for sending data over a network comprising metapolicy storage means for storing metadata relating to a content of data and a metapolicy making the metadata and a transmission priority correspond, and priority assigning means for referring to the metapolicy, deciding a transmission priority of the data based on the metadata, and setting the transmission priority in a part of packet header information generated from the data.

The present invention is also provided with a data sending unit according to claim 4, further comprising metadata adding means for adding metadata defined based on a content of data that is the subject of communication.

The present invention is also provided with a data communication control program recording medium recorded with a data communication control program for implementing steps for implementing the data communication control method on a computer.

The present invention operates in the following manner. It is taken that metadata defined based on data content added to data that is the subject of communication and a metapolicy making sending priority correspond with each metadata or a communication control table making communication control correspond with each priority are preset at the DS domain.

At the DS domain, when data is communicated, the data sending unit puts metadata into the data that is the subject of communication, refers to the metapolicy, and decides the priority ( for example, an AF value of DSCP ) of the data that is the subject of communication based on the added metadata. The packet with the priority set at part of the header information of the packet generated from the data is then sent.

The data transmission unit receiving the sent packets then refers to the set communication control table, determines the priority of the packet class and the packet discard level based on priority set at the packet header information, and sends the packet to a further data transmission unit using communication control corresponding to this priority. Namely, sending of the received packet can be given priority in cases where the priority of the received packet is higher than the priority of a normal packet. Packet discard processing is then carried out according to priority in cases where the amount of data exceeds the amount that can be processed.

The present invention therefore sets data communication on the side of the unit sending the data based on metadata reflecting the content of the data that is the subject of communication, and on the side of the unit transmitting the data, data communication is carried out in a prioritized manner based on the priority already set as header information of the data that is the subject of communication. As a result, it is possible to implement priority control of data communication based on the content of the distributed data.

### BRIEF DESCRIPTION OF THE DRAWINGS

FIG. 1 is a view showing an example configuration for a system of an embodiment of the present invention.

FIG. 2 is a view showing an example of metadata and metapolicy.

FIG. 3 is a view showing an example of metadata and metapolicy.

FIG. 4 is a view showing an example of metadata and metapolicy.

FIG. 5 is a view showing an outline of the process flow of the present invention.

FIG. 6 is a view showing an example of a DSCP table.

FIG. 7 is a view illustrating Diffserv.

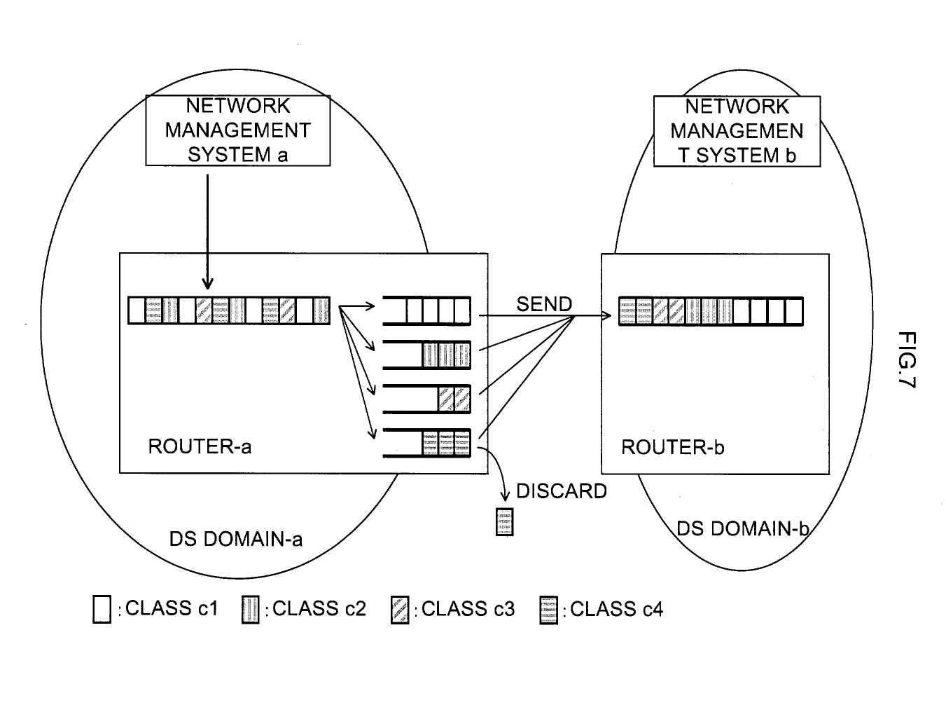

FIG. 8 is a view illustrating a signal distribution queue of a router for Diffserv.

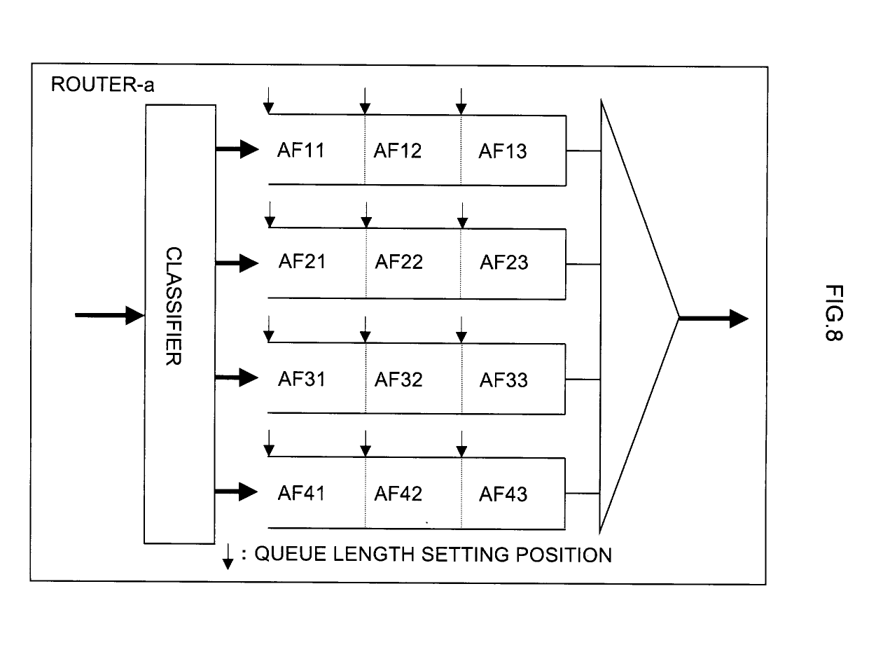

### DETAILED DESCRIPTION OF THE PREFERRED EMBODIMENT

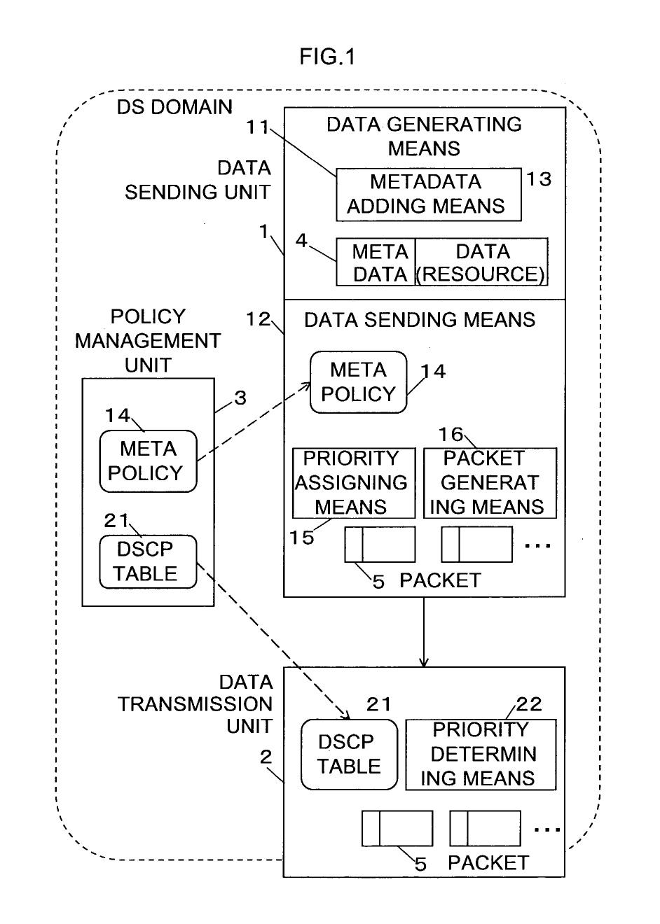

FIG. 1 is a view showing an example configuration for a system of an embodiment of the present invention. The system of the present invention is taken to be formed within a DS domain, and is configured from a data sending unit 1, a data transmission unit 2, and a policy management unit 3.

The data sending unit 1 is means for transmitting data that is the target of communication, and is implemented as an application layer entity. The data sending unit 1 comprises a data generating module 11 and a data sending module 12.

The data generating module 11 is means for generating data constituting a message, acquires data from other processing modules, and transmits data with metadata (resource) 4 to the data sending module 12. The data generating module 11 is equipped with metadata adding module 13. The metadata adding module 13 is means for generating metadata defined from the content of the resource 4 and adding this metadata to the resource 4. The metadata adding module 13 generates metadata using, for example, XML (eXtensible Markup Language) metatags based on information and values extracted from the generator of the resource 4, and the data format, title, and application (purpose of transmission) etc. of the resource 4 and adds the generated metadata to the resource 4.

The data sending module 12 is means for putting a resource 4 received from the data generating module 11 into a state enabling priority control and then transmitting IP packets. The data sending module 12 is equipped with a metapolicy 14, priority assigning module 15, and a packet generating module 16.

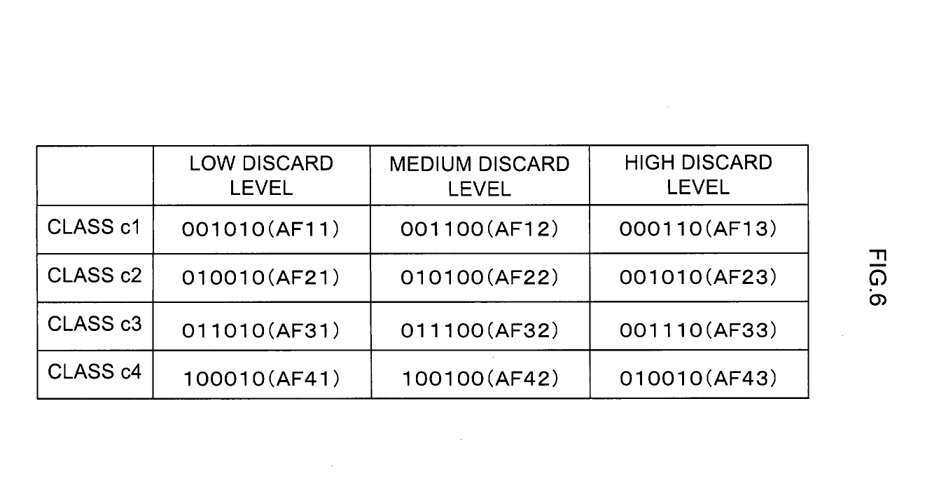

The metapolicy 14 is a set of rules deciding the manner of handling the flow of data during data communication control operating in a predetermined manner within the DS domain and is data indicating what kind of DSCP is set for what kind of metadata. DSCP conforming to, for example, DSCP definition at IETF is used as the DSCP assumed for the metapolicy 14. In this case, the metapolicy 14 consists of a rule that decides upon the AF value of 12 in FIG. 6 for the value for the metadata. For example, with speech data such as that in internet telephony, the four class division for DSCP of FIG. 6 are made to correspond in the following manner:

Class c1=calls for communication system management (used in a telephone communication system);

Class c2=calls making urgent contact to within organizations such as the police, fire-fighting, emergency services department, etc. (used in applications);

Class c3=emergency notification to organizations such as the police, fire-fighting, emergency services department, etc. (used in applications); and

Class c4=normal calls (used in applications).

A packet discard level is then set with respect to data within the same class based on data such as part of the data content, caller information, and destination information or the like. The discard level is decided as the AF level set by the rules of the metapolicy 14. The metapolicy 14 is distributed by the policy management unit 3 provided within the DS domain.

The priority assigning module 15 is means for referring to the metapolicy 14 and deciding priority for the resource 4 based on metadata for the resource 4 received from the data generating module 11. The packet generating module 16 divides up the resource 4 passed over from the data generating module 11, generates a packet 5, and sets a priority received from the priority assigning module 15 at the DS field of the TOS of the IP header added to the packet 5.

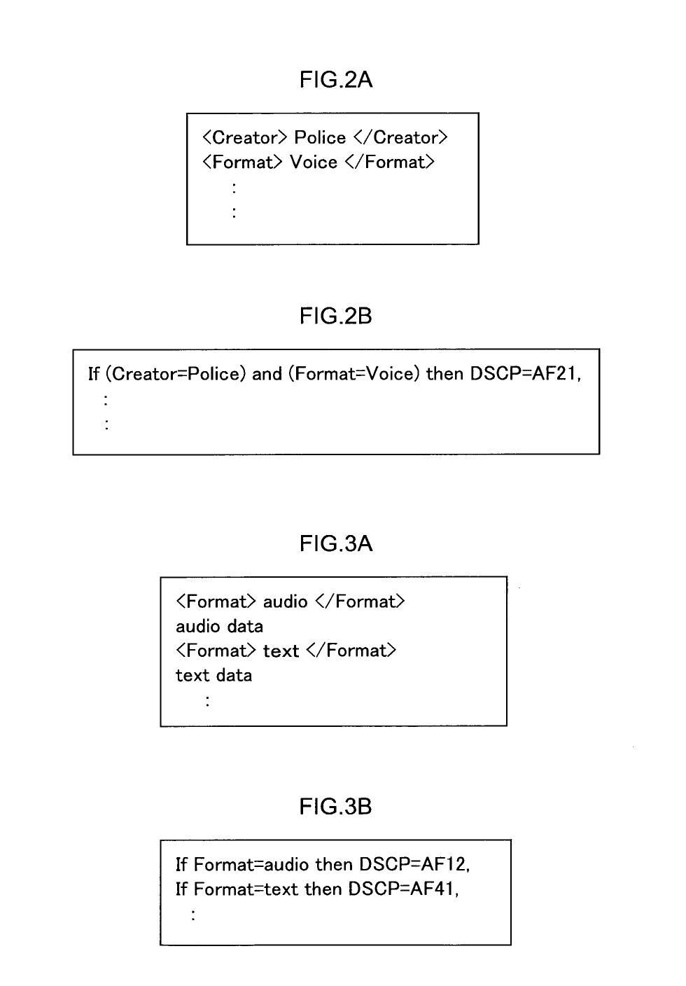

FIG. 2 to FIG. 4 show metadata and metapolicy examples. An example of metadata generated in the case where the resource 4 is digital voice data for a call made from the police using an internet telephony service is shown in FIG. 2A. The metadata adding module 13 sets a value “Police” indicating the police in a metatag <Creator> indicating the data generator and sets a value “Voice” for information showing the presence of digital voice data in the metatag <Format> indicating the data format based on the data format and data generator information of data constituting the resource 4 and then generates metadata for adding to the data (resource) in the following manner.

<Creator>Police</Creator>

<Format>Voice</Format>

An example of a metapolicy 14 corresponding to the metadata shown in FIG. 2A is shown in FIG. 2B. The metapolicy 14 of FIG. 2B means that when the value for <Creator> for the metadata endowed upon the resource 4 is “Police” and the value for the <Format> is “Voice”, the value=AF21 set using a DSCP table 21 described later is set in the DS field of the TOS of the IP header. For example, the priority assigning module 15 equipped with the metapolicy 14 of FIG. 2B sets AF21 as the DSCP for the resource 4 when metadata indicating that the resource as shown in FIG. 2A is received and notifies the packet generating module 16.

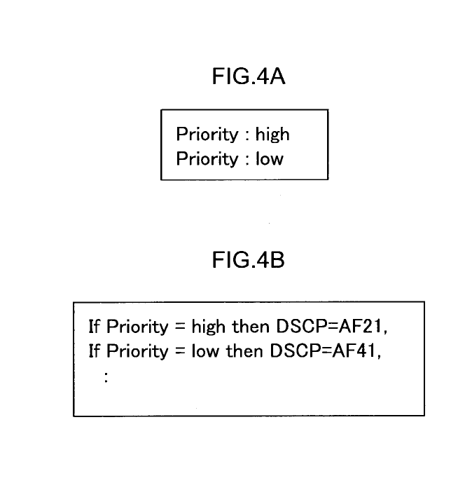

Further, an example of metadata generated when the resource 4 is Web data, i.e. HTML format data is shown in FIG. 3A. The metadata adding module 13 sets information showing that a metatag <Format> indicating the data format is voice data to “audio” and information showing the presence of text data to “text” based on the data format of the resource 4, generates the following metadata, and adds this to HTML data constituting the resource 4.

<Format>audio</Format>

audio data

<Format>text</Form at>

text data

An example of a metapolicy 14 corresponding to the metadata shown in FIG. 3A is shown in FIG. 3B. The metapolicy 14 of FIG. 3B means that when the value of <Format> of the metadata supplied to the resource 4 is “audio”, AF12 of the DSCP is set to the DS field of the TOS of the IP header, and when the value of <Format> is “text”, AF41 of the DSCP is set to the DS field of the TOS of the IP header. The priority assigning module 15 equipped with the metapolicy 14 of FIG. 3B sets AF12 as the DSCP for the resource 4 when the value of <Format> for the metadata added to the resource 4 is “audio” and notifies the packet generating module 16. Further, AF41 is set as the DSCP for the resource 4 when the value of <Format> for the metadata added to the resource 4 is “text” and notifies the packet generating module 16.

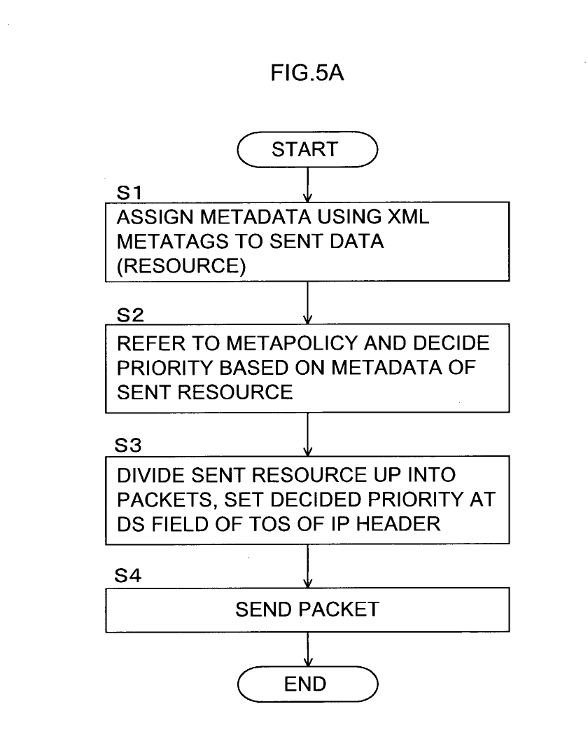

Further, an example of metadata generated when the resource 4 is mail is shown in FIG. 4A. The metadata adding module 13 sets priority as shown, for example, in the following, directly to the header of the mail constituting the resource 4.

Priority: high

Priority: low

An example of the metapolicy 14 corresponding to the setting for the header of the mail of FIG. 4A is shown in FIG. 4B. The metapolicy 14 of FIG. 4B sets AF21 of the DSCP to the DS field of the TOS of the IP header when the value of the priority of the header of the mail constituting the resource 4 is “high”. Further, when the value of “Priority” is “low”, this means that AF41 of the DSCP is set to the DS field of the TOS of the IP header. The priority assigning module 15 equipped with the metapolicy 14 of FIG. 4B sets AF21 as the DSCP for the resource 4 when the value of “Priority” of the header for the mail provided for the resource 4 is “high”, sets AF41 as the DSCP for the resource 4 when the value for Priority is low, and notifies the packet generating module 16.

The data transmission unit 2 is means that refers to the priority set at the IP header of the packet 4 and then executes communication control for the packet 4 and is implemented as a network layer entity. The data transmission unit 2 is equipped with a DSCP table 21 and a priority determining module 22.

The DSCP table 21 is a table defining dividing up of the data flow into classes and the operation of communication control over a network with regards to packet discarding or the like for each class. The data transmission unit 2 is provided with a DSCP set conforming to RFC2475 of the IETF in advance, and this therefore does not have to be distributed from the policy management unit 3 to the DSCP table 21 when DSCP conforming to the IETF is used.

The priority determining module 22 is means for dividing packets 5 into classes according to the priority set at the IP header, deciding upon transmission order, and performing packet transmission control in accordance with the decided order. For example, when AF21 is set at the DS field of the IP packet of packet 5 generated from the resource 4, the priority determining module 22 refers to the DSCP table 21, classifies the packet 5 into class c2, and recognizes the presence of a low discard level. Here, class c2=low priority means the priority is the second highest and when low discard level means that packet discarding is not carried out, the priority determining module 22 stores this packet 5 in a queue for packets of the second highest priority in accordance with the class c2 and does not subject the packet 5 to discard processing. As a result, the priority determining module 22 can transmit packets for calls made by the police using internet telephony with a greater priority than other packets. It is also possible to ensure that these packets are not discarded when the amount of data to be processed is excessive.

The policy management unit 3 is a server for managing the metapolicy 14 defining the behavior of the data communication control of each node within a DS domain and managing the DSCP table 21. The policy management unit 3 distributes the metapolicy 14 to the data sending unit 1 and distributes the DSCP table 21 to the data transmission unit 2.

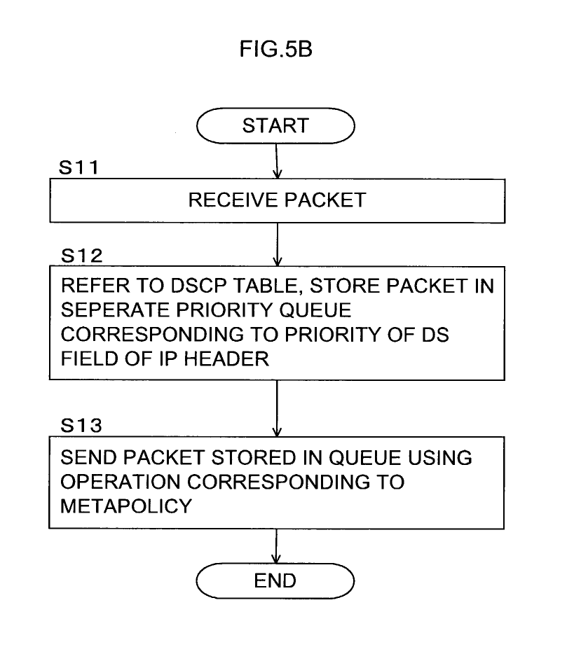

An outline of the process flow of the present invention is shown in FIG. 5. FIG. 5A is a view showing the flow of processing at the data sending unit 1. The metadata adding module 13 of the data sending unit 1 adds metadata employing, for example, XML metatags, to the data (resource) constituting the transmission target (step S1). The priority assigning module 15 refers to the metapolicy 14 and decides upon a priority determined in advance by the DSCP table 21 based on the metadata of the transmitted resource 4 (step S2). The packet generating module 16 then divides the transmitted resource up into packets 5, sets the decided priority at the DS field of the TOS of the IP header (step S3), and transmits the packet 5 (step S4).

FIG. 5A is a view showing the flow of processing in the data transmission unit 2. When the priority determining module 22 of the data transmission unit 2 receives the packet 5 (step S11), the DSCP table 21 is referred to, and the packet is stored in a queue for each class corresponding to the priority of the DS field of the IP header (step S12). The packet 5 stored in the queue is then transmitted using a prescribed corresponding operation at the metapolicy 14 (step S13).

In the above, a description is given of practical implementations of the present invention but various modifications are possible within the scope of the present invention. The control program implementing the present invention may be stored on an appropriate recording medium readable by a computer such as portable memory media, semiconductor memory, or a hard disc or the like, and may be provided through recording on such a recording media, or through exchange utilizing various communications networks via a communications interface.

In the above description, according to the present invention, priority is set according to content of the resource 4 using the data sending unit 1 based on the metapolicy 14 controlled and managed by the policy management unit 3 within the DS domain and control of the transmission of packets is carried out according to this priority using the data transmission unit 2.

As a result, data communication control can be implemented based on the content of the resource 4. For example, with Internet telephony services, it becomes possible to handle distributed speech data according to call content such as emergency notification or making emergency contact. It is therefore possible to distribute calls giving priority to calls of a higher urgency based on call content regardless of the call destination, even in situations such as with natural disasters where it is easy for data communication to become congested.

What is claimed is:

1. A data communication control method for carrying out data communication control over a network, comprising the steps of:
adding metadata related with data that is a subject of communication to the data;
referring to a metapolicy making the metadata and a transmission priority correspond, deciding a transmission priority of the data based on the metadata, and setting the transmission priority in a part of packet header information generated from the data; and
referring to a communication control table making communication control behavior correspond with each transmission priority, and deciding data packet transmission order based on the transmission priority.

2. A data communication control system for carrying out data communication control comprising a data sending unit for sending data over a network and a data transmission unit for transmitting the data in accordance with header information of the received data,
wherein the data sending unit comprises:
metapolicy storage means for storing metadata relating to the content of the data and a metapolicy making the metadata and a transmission priority correspond; and
priority assigning means for referring to the metapolicy, deciding a transmission priority of the data based on the metadata, and setting the transmission priority in a part of packet header information generated from the data; and
wherein the data transmission unit comprises:
communication control table storage means for storing a communication control table making communication control correspond with each transmission priority; and
priority determining means for receiving the packet, referring to the communication control table, and determining priority of the data based on the transmission priority set in the header information.

3. A data communication control system according to claim 2, wherein the data sending unit comprises metadata adding means for adding metadata defined based on the content of the data that is a subject of communication to the data.

4. A data sending unit for sending data over a network comprising:
metapolicy storage means for storing metadata relating to a content of data and a metapolicy making the metadata and a transmission priority correspond; and
priority assigning means for referring to the metapolicy, deciding a transmission priority of the data based on the metadata, and setting the transmission priority in a part of packet header information generated from the data.

5. A data sending unit according to claim 4, further comprising
metadata adding means for adding metadata defined based on a content of data that is the subject of communication.

6. A data communication control program recording medium recorded with a data communication control program for implementing steps for implementing the data communication control method as disclosed in claim 1 on a computer.
